(19) United States
(12) Patent Application Publication
(10) Pub. No.: US 2002/0097581 A1
(43) Pub. Date: Jul. 25, 2002

(54) LAMP COVER STRUCTURE FOR EASY ASSEMBLY

(76) Inventor: Wen-Chang Wu, Chang Hua Hsien (TW)

Correspondence Address: DOUGHERTY & TROXELL, SUITE 1404, 5205 LEESBURG PIKE, FALLS CHURCH, VA, 22041, US

(21) Appl. No.: 09/764,265

(22) Filed: Jan. 19, 2001

(51) Int. Cl. F21V 11/00

(52) U.S. Cl. 362/358; 362/351

(57) ABSTRACT

The invention is related to a kind of lamp cover structure for easy assembly. It mainly comprises of a top ring on the very top of the lamp cover, a bottom ring, of which the perimeter is greater than that of the top ring, and a support frame connecting the top ring and the bottom ring. There are support bars extend radiantly from the top ring. The end of the bars are folded upward to fasten the clip hooks on the ring rim. On the locations of the upper transversal arch bars of the support frame near the clip hooks, concave clip grooves are bent downward to hit exactly the clip hooks. Upon the location of the support portion on a support frame, the bottom ring extrudes inward near inclined support bars accordingly, thus, the lower transversal arch bars on the support frame hit exactly the top of a bottom ring. Through the fixture of support bars, the support frame connects the support bars and the bottom ring to constrain the movement of the support frame. For the assembly, one may lay the support frame horizontally. The lamp cover can thus be assembled with minimum volume to achieve the objectives of easy assembly and to reduce storage volume and delivery cost.

### BACKGROUND OF THE INVENTION

1) Field of the Invention

The invention is related to a kind of lamp cover structure for easy assembly, of which the support bars extend radiantly from the top ring. The end of the bars are folded upward to fix on the clip hooks of the ring rim, thus the clip grooves on the upper transversal arch bars of the support frame hit exactly the clip hooks. On the support locations of the support frame, support bars accordingly extruded on the bottom ring, thus the lower transversal arch bars on the support frame hit exactly the upper part of the bottom ring. Through the fixture of support bars, the support frame connects the support bars and the bottom to constrain the movement of the support frame. For the assembly, one may lay the support frame horizontally. The lamp cover can thus be assembled with minimum volume to achieve easy assembly and to reduce storage volume and delivery cost.

2) Description of the Prior Art

Please refer FIG. 6, the traditional lamp cover 5. Most of the support frames directly connect the top ring and the bottom ring to form the lamp cover structure. There are many practical defectives for this kind of lamp cover structure as follows:

The prior lamp covers form certain structural shape, therefore, the covers can not be compressed during delivery and the products take too much space. The storage and delivery volume for this kind of product can not be reduce, hence the delivery cost is raised. It leads to cost increase.

Due to the above defectives, the products lead to current disadvantage in usage. On the basis of thorough research for constant improvement, the inventor finally developed the invention, a kind of lamp cover for easy assembly and great improvement in practical usage.

### SUMMARY OF THE INVENTION

The primary objective of the invention is to provide a kind of lamp cover structure for easy assembly. It mainly comprises of a top ring, a bottom ring, and a support frame, which exactly connects the top ring and the bottom ring. The top ring extrudes radiantly with support bars. The ends of support bars are folded clip hooks, which are bent upward to form clip hooks for the fixture of the ring rim. On the location of the upper transversal arch bar on the support frame near the clip hooks, concave clip grooves are bent downward to hit exactly the clip hooks. Upon the location of a support frame, the bottom ring extrudes the support bars accordingly, thus the lower transversal arch bars on the support frame hit exactly the top of a bottom ring. Through the fixture of support bars, the support frame connects the support bars and the bottom to constrain the movement of the support frame. For the assembly, one may lay the support frame horizontally. Therefore, the lamp cover can be assembled with minimum volume to achieve easy assembly and to reduce storage volume and delivery cost.

The additional objective of the invention is to provide a kind of lamp cover structure for easy assembly. The support frame comprises of dual vertical arch bars and upper arch bars. The bottom of the support frame forms insert tenons, which are perpendicular to the bottom ring and insert the ring bases of the bottom ring. On the support portion of the support frame on the bottom ring, there are accordingly inward ring bases, which are empty ring structure. The insert tenons exactly insert the positioning ring bases. After the insert of the tenons on the support frame into the ring bases, the upper transversal arch bars hit exactly the clip hooks on the end of support bars for the movement constraint of the support frame. Therefore, the lamp cover can be assembled with minimum volume to achieve easy assembly and to reduce storage volume and delivery cost.

The followings are brief description and legend for optimal embodiments of the invention for committee's better understanding in the structural characteristics and operations of the invention.

### BRIEF DESCRIPTION OF THE DRAWINGS

FIG. 1 is an exploded drawing of the invention.

FIG. 2 is an isometric assembly drawing of the invention.

FIG. 2A is an enlarged planar drawing of the top ring and the support portion on the support frame.

FIG. 2B is an enlarged elevation drawing of the top ring and the support portion on the support frame.

FIG. 3 is the folded and unfolded drawing of an embodiment for the invention.

FIG. 4 is another drawing of an embodiment for the invention.

FIG. 4A is an enlarged drawing of the top ring and the connection portion on the support frame.

FIG. 5 is an embodiment drawing of a lamp cover for the invention.

FIG. 5A is an enlarged drawing of the adhesion portion.

FIG. 6 is an isometric drawing of the prior lamp cover.

### DETAILED DESCRIPTION OF THE PREFERRED EMBODIMENT

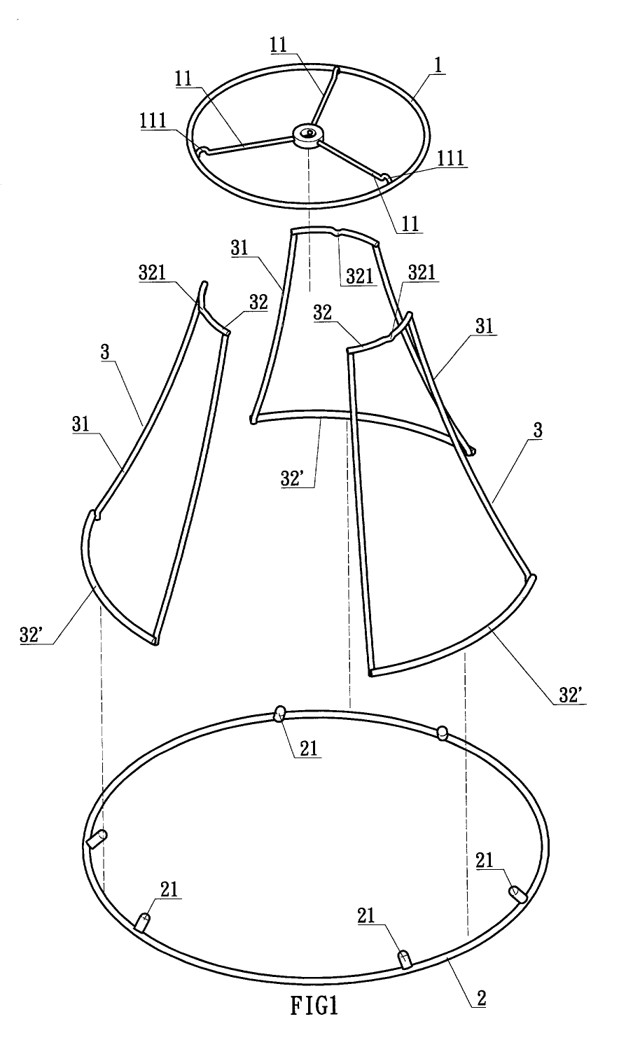

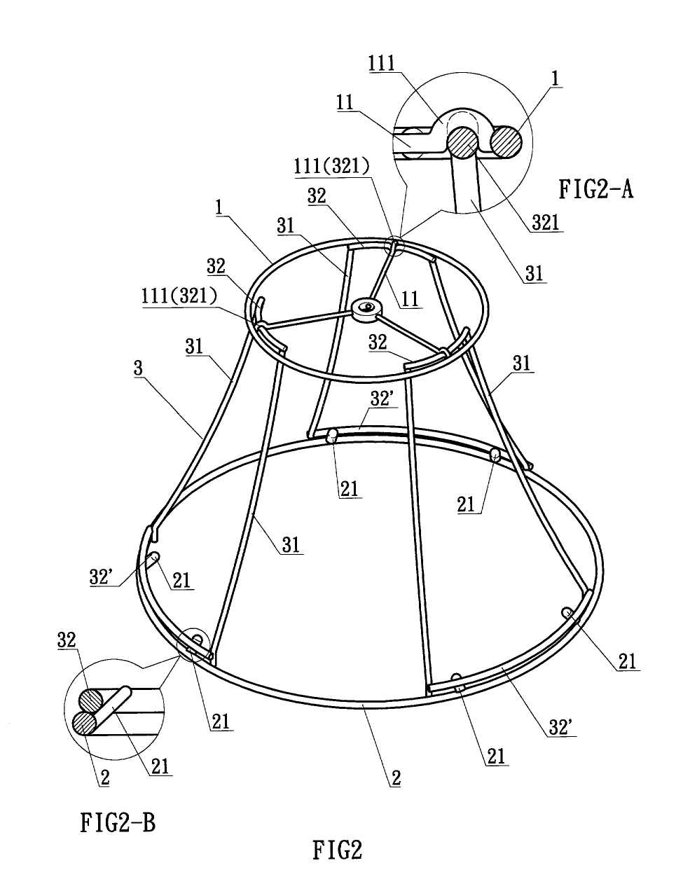

Please refer FIG. 1 for the comprehension of the structure for the invention. It comprises of a top ring 1 on the very top of the lamp cover, a bottom ring 2, of which the perimeter is greater than that of the top ring, and a support frame 3 for the connection of the top ring and the bottom ring.

The top ring 1 made of metal is a round-cylinder structure and exactly hits the stand bar of an table lamp. The top ring extrudes radiantly to form support bars 11. The end of the bar is a folded clip hook 111, which is fixed on the rim of the top ring for the connection and interlock of the support frame 3.

The bottom ring 2 is located on the support portion of a support frame 3 and extrudes inward orderly to form inclined support bars 21. Thus, a clip space S is formed between the support bars 21 and the bottom ring 2. The lower transversal arch bar 32′ on the support frame 3 hits exactly with the clip space above the bottom ring 2. Through the clip of the support bars 21, the support frame 3 connects the support bars 21 and the bottom ring for the movement constraint of the support frame 3.

The support frame 3 comprises of dual vertical arch bars 31 to match the upper and lower transversal arch bars 31. The upper transversal arch bars 32 match the curvature of the top ring and the lower transversal arch bars 32′ match the curvature of the bottom ring. On the location of the upper transversal arch bar 32 of the support frame near the support bar 11, the concave clip grooves 321 hit exactly the clip hooks 111. The lower transversal arch bars on the support frame hit exactly the bottom ring 2 for the movement constraint of the support frame.

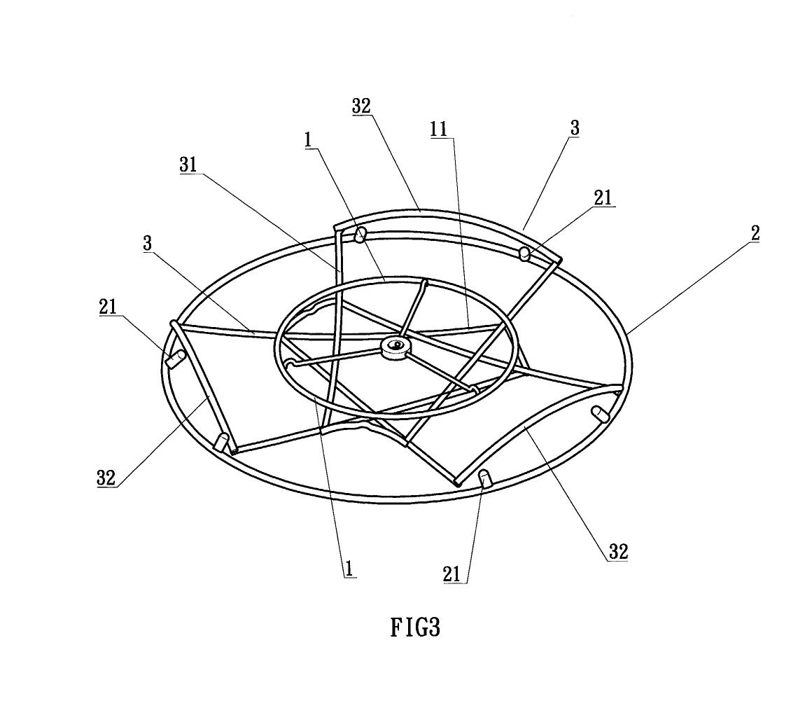

Please refer FIG. 3, the folded and unfolded embodiment drawing of the invention. For the assembly, the support frame 3 should be removed and laid horizontally. Thus, the lamp cover can be assembled with minimum volume for convenient assembly and volume reduction to achieve the effect of delivery cost decrease.

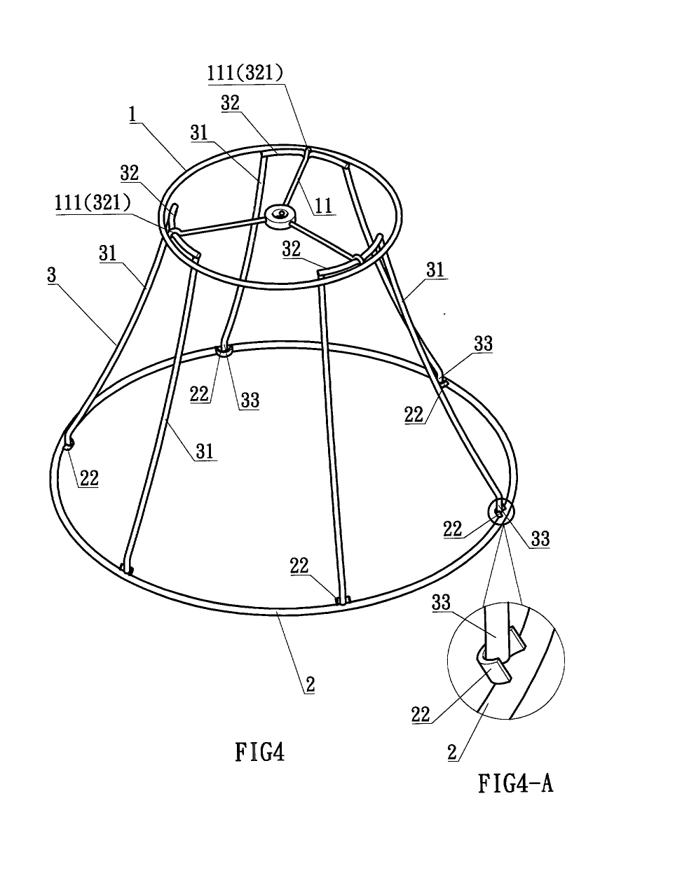

As shown in FIG. 4, another embodiment drawing, the support frame comprises of dual vertical arch bars 31 and upper arch bars 32. The bottom of the support frame forms insert tenons 33, which are perpendicular to the bottom ring and insert the ring bases of the bottom ring. On the support portion of the support frame 3 on the bottom ring 2, there are accordingly inward ring bases 22, which are in empty ring structure. The insert tenons 33 exactly insert the positioning ring bases 22. After the insert of the tenons 33 on the support frame into the ring bases 22, the upper transversal arch bars 32 hit exactly the clip hooks 111 on the end of support bars for the movement constraint of the support frame 3.

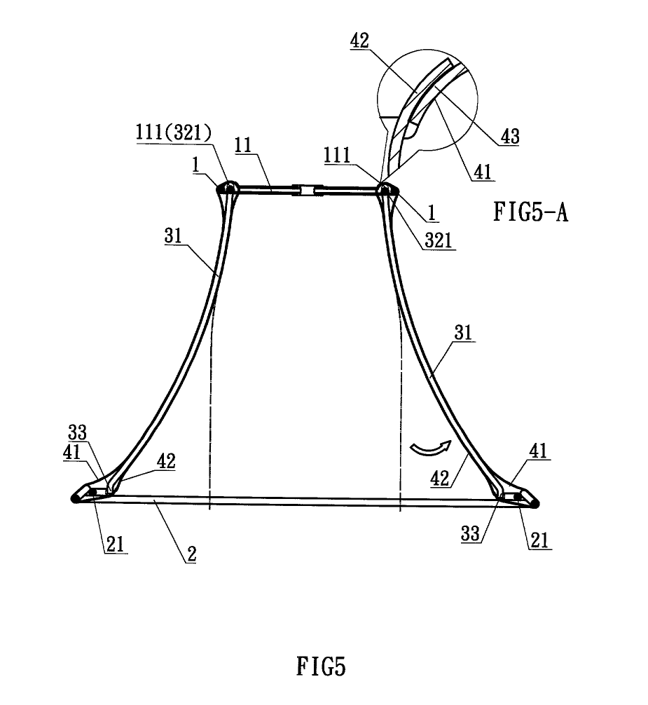

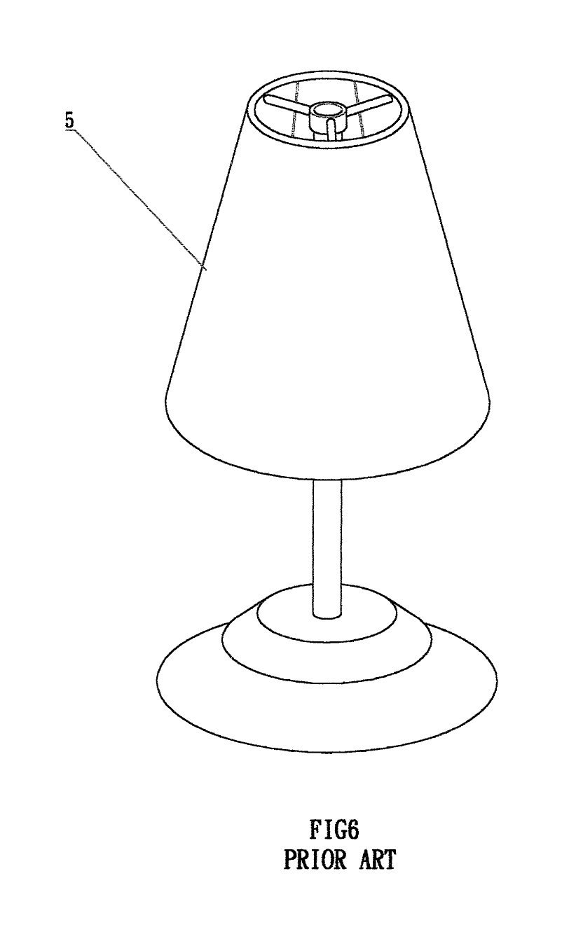

Please refer FIG. 5. After the assembly, a cloth cover can be covered on the exterior area between the top ring and the bottom ring. One may make the exterior cloth 41′ tight in advance and fasten it on the rim of the support frame 3, then, lay a inner layer cloth 42 on the interior of the support frame 3. On the appropriate locations, three are adhesion bands 43 on the inner and external cloth to wrap the support frame. The frame is not exposed and the structure of combined cloth is formed for the effect of esthetics. It can also be folded together with the lamp cover to reduce volume and to decrease delivery cost.

The above explanation is a substantial embodiment of the invention, which provides greater practical performance and simplification than products of prior art. Furthermore, the present invention meets all new patent application requirements and is lawfully submitted for review and the granting of the commensurate patent rights to thereby encourage the spirit of invention and its rightful protection under the patent law.

1. The invention, a kind of lamp cover structure for easy assembly, mainly comprises of a top ring on the very top of the lamp cover, a bottom ring, of which its perimeter is greater than that of the top ring, and a support frame connecting the top ring and the bottom ring; furthermore, the support bars extend radiantly from the top ring and the ends of the bars are bent upward to form the clip hooks of the ring rim; also, upon the location of the support portion on a support frame, the bottom ring extrudes inward inclined support bars accordingly to form a clip space for the positioning and support of the lower transversal arch bars on the support frame; moreover, the support frame comprises of dual vertical arch bars to match the upper and lower transversal arch bars, of which, the upper transversal arch bars match the curvature of the top ring and the lower transversal arch bars match the curvature of the bottom ring; furthermore, on the location of the upper transversal arch bars on the support frame near the support bars, the bars are bent downward to form concave clip grooves, which hit exactly the clip hooks and the lower transversal arch bars on the support frame hit exactly the bottom ring for the movement constraint of the support frame; thus, for the assembly, one may lay the support frame horizontally, then the lamp cover can be assembled with minimum volume to achieve the objectives of easy assembly and to reduce storage volume and delivery cost.

2. As mentioned in claim 1 of a kind of lamp cover structure for easy assembly, mainly comprises of a top ring on the very top of the lamp cover, a bottom ring, and a support frame connecting the top ring and the bottom ring; furthermore, on the support portion of the support frame, the top ring extends radiantly to form support bars, of which, the ends are bent upward to form the clip hooks onto the ring rim; also, on the support portion of the support frame near the bottom ring, there are accordingly inward inclined ring bases, which are empty ring structure, thus the insert tenons can be exactly inserted into the positioning ring bases for the movement constraint of the support frame; also, the support frame comprises of dual vertical arch bars and upper and lower arch bars, thus on the upper transversal arch bars on the support frame near the support bars on the top ring, the bars are bent downward to form concave grooves, which match the clip hooks; also, the bottom portions of the support frame are bent to form insert tenons, which are perpendicular to the bottom ring and fit exactly with the base ring; after the insert of the tenons on the support frame into the ring base, the upper transversal arch bars hit exactly the clip hook on the ends of the support bars and the lower transversal bars hit exactly the bottom ring; therefore, the lamp cover can be assembled with minimum volume to achieve the objectives of easy assembly and to reduce storage volume and delivery cost.

3. As mentioned in claim 1 of a kind of lamp cover structure for easy assembly equips a cloth cover enclosing the exterior area between the top ring and the bottom ring; furthermore, one may make the exterior cloth tight in advance and fasten it on the rim of the support frame, then, equip an inner layer of cloth on the interior of the support frame; also, on the appropriate locations, three are adhesion bands on the inner and external cloth to form a structure with the combination of the inner and external cloth for the effect of esthetics; moreover, it can also be folded together with the lamp cover to reduce volume and to achieve the effects of storage volume reduction and delivery cost decrease.
